(19) United States
(12) Patent Application Publication
(10) Pub. No.: US 2013/0098491 A1
(43) Pub. Date: Apr. 25, 2013

(54) PRESSURE COMPENSATION DEVICE IN AIRCRAFT

(71) Applicants: Juan Zuniga Sagredo, Madrid (ES); Carlos Fernandez Alonso, El Hoyo de Pinares (ES); Ignacio Jorge Outon Hernandez, Madrid (ES)

(72) Inventors: Juan Zuniga Sagredo, Madrid (ES); Carlos Fernandez Alonso, El Hoyo de Pinares (ES); Ignacio Jorge Outon Hernandez, Madrid (ES)

(73) Assignee: AIRBUS Operations S.L., Getafe (ES)

(21) Appl. No.: 13/352,414

(22) Filed: Jan. 18, 2012

(30) Foreign Application Priority Data
Oct. 24, 2011 (ES) 201131710

(51) Int. Cl. F16L 55/04

(52) U.S. Cl. 138/30

(57) ABSTRACT

Pressure compensation device (100) deployed in an element that contains a flammable substance that compensates pressures between interior (101) of the element and exterior atmosphere (102) in which said element is deployed, by means of a continuous primary circulation (300) of air through primary channel (103) in said device (110) that communicates interior (100) and exterior (102) of the element, further comprising a secondary channel (104) integrated in the device (100) itself, communicating interior (102) and exterior (102) of the element, comprising said secondary channel (104) in the interior zone of the element a sheet (105) such that, in the event primary continuous circulation (300) of air through primary channel (103) is interrupted, said continuous circulation continues through secondary circulation (400) of air to interior (101) of the element, this secondary circulation (400) of air being capable of breaking sheet (105) of secondary channel (104).

### FIELD OF THE INVENTION

The present invention refers to a pressure compensation device for an aircraft, more specifically a pressure compensation device for an element of an aircraft that contains an flammable substance in its interior.

### BACKGROUND OF THE INVENTION

In this document a new concept of pressure compensation device is disclosed that integrates a device to protect the deposit inside of which there are inherent excessive pressure differences that could lead to a structural failure of the wing.

In general integral fuel deposits of an aircraft contain in their interior a flammable substance in liquid state together with a mixture of gasses (air, fuel vapours, etc.) that could generate high pressures in a deposit that is completely sealed. Thus devices are needed in an aircraft that are capable of compensating the interior and exterior pressure of said deposits: these devices are generally known under the name of pressure compensation devices. The interior and exterior pressures must be equalized in order to avoid excessive loads on the structure of the aircraft.

However, in the normal functioning of a pressure compensation device there can be situations in which said device could become blocked. Therefore, the element of the aircraft in which the pressure compensation device is deployed also comprises a system associated to the same, called Over Pressure Protection (OPP). The over pressure protection system is separated from the pressure compensation device in a manner that the normal compensation, in the case in which the element of the aircraft to be protected is a fuel device, is such that the over pressure protection system communicates with the exterior of the deposit by means of a perforation of the fuel deposit independent from the perforation of the pressure compensation device. Thus, in the configuration of the known art, the over pressure protection system only begins to function in the event that the pressure compensation device is blocked.

The problem that solutions of this type entail is that to be implemented they require two perforations in the fuel deposit, one for the pressure compensation device properly speaking, and the other for the over pressure protection system. This entails problems from the structural point of view, given that the structure is weakened, and from an aerodynamic point of view, because the resulting structure generates greater aerodynamic resistance. Furthermore, the resulting structure is complex, which, in consequence, is reflected in higher costs.

Another of the problems raised by the known solutions is that it is necessary to reinforce the zones adjacent to the perforations made for housing the pressure compensation device and the over pressure protection system, generally by means of reinforcing frames that are complicated to make, add weight to the overall structure of the aircraft, and have a high cost of manufacturing and installation, while at the same time they imply managing different spare parts.

Furthermore, as in the solutions known at this time there are two openings to the exterior, corresponding to the exterior outlets of the aircraft for the pressure compensation device and the over pressure protection system, a lot of noise is generated, something which would be desirable to limit.

The present invention is oriented to the solution of these problems.

### SUMMARY OF THE INVENTION

Thus the present invention refers to a pressure compensation device deployed in an element of an aircraft that contains a flammable liquid substance together with a mixture of gases in its interior, in such a way that said device compensates pressure in the interior of the element and the exterior atmosphere, in which the same is deployed, by means of a constant primary circulation of air through a primary channel in said device that communicates the interior and the exterior of the element, said device comprising, furthermore, a secondary channel integrated in the device itself that communicates the interior and the exterior of the element. In accordance with the invention, the secondary canal in the exterior zone of the element comprises a diaphragm or sheet, such that in the event the constant primary circulation of air of the primary channel is interrupted, said circulation continues through a secondary flow of air to the interior of the element, this secondary flow having the capability of breaking the diaphragm of the secondary channel.

Furthermore, in accordance with the present invention, the pressure compensation device, the secondary channel, and the primary channel share the same communication outlet towards the exterior of the element in question.

In this way, the invention integrates in the same device a pressure compensation device and over pressure protection system while maintaining the functionality of both in a separate manner.

Thus, the pressure compensation device of the invention provides the following advantages:
Only one perforation is required in the element in which the device is going to be placed, which entails a clear structural advantage and an aerodynamic advantage.
The device of the invention maintains two distinct and separate functionalities but integrated in the same device, in such a way that the total volume of the system is reduced, with the corresponding weight savings.
Given that before what used to be two different elements are unified in the same device, a reduction in the complexity of installation and structural support is obtained as well as an overall reduction in the cost of the system.

Other features and advantages of the present invention will be disclosed in the detailed description that follows from exemplary embodiments of its object in relation to the accompanying Figures.

### DESCRIPTION OF THE FIGURES

FIG. 1 shows a bottom view of a portion of the wing of an aircraft on which is pointed out the typical position of the pressure compensation device and the over pressure protection system, in accordance with the known prior art.

FIG. 2 shows a schematic view of the elements that form a pressure compensation device in accordance with known prior art.

FIG. 3 shows the obturation of the pressure compensation device shown in FIG. 2.

FIG. 4 shows a schematic view of the mounting of a pressure compensation device in accordance with prior known art on an access cover to the fuel deposit.

FIG. 5 shows a schematic view of the over pressure protection system in accordance with the prior known art, as well as the functioning of the same following the obturation of the pressure compensation device.

FIG. 6 shows a schematic view of the mounting of an over pressure protection device in accordance with prior known art on an access cover to the fuel deposit.

FIG. 7 shows a schematic view of the configuration of a pressure compensation device in accordance with the present invention.

### DETAILED DESCRIPTION OF THE INVENTION

In accordance with the known art, pressure compensation device 1, deployed in a specific element which forms part of an aircraft, such that said element that contains in its interior a flammable substance, is the device which, in normal operating conditions, makes it possible to maintain a limited pressure difference between the interior and exterior of said element. Normally, pressure compensation device 1 is deployed in the fuel deposit of an aircraft, and is designed to carry out the following functions:
enable the entrance and exit of air to the fuel deposit so as to compensate the pressure;
avoid the entrance into the fuel deposit of flames that could exist in the exterior: “Flame Arrestor”;
reduce as much as possible the aerodynamic resistance of the air output and input channel;
avoid the possibility of fuel spills.

To fulfil the requirements that have been mentioned, pressure compensation device 1, in accordance with known art and as is clear from FIG. 2, comprises channel 2 that communicates the interior with the exterior of the element in which pressure compensation device 1 is deployed, aerodynamic opening 3 that enables the entering and exiting of air through channel 2 with the minimum aerodynamic resistance possible, an upper lip 4, located at a height with respect to the element of the aircraft (in particular, the fuel deposit) such that under no operating circumstances the level of the flammable substance under pressure can overrun said upper lip 4, avoiding in this way the possibility of the flammable substance spilling towards the exterior.

Pressure compensation device 1 can be mounted on access cover 20 of the fuel deposit when the element on which it is deployed is a fuel deposit, as shown in FIG. 4, or it can be mounted over any type of outlet that could exist in the structure that comprises the aircraft in question.

Furthermore, pressure compensation device 1 comprises in the interior of channel 2 an anti-fire device 5, that avoids the entry of flames to the interior of the element. Anti-fire device 5 comprises a series of small diameter channels and a longitudinal channel such that it is not possible for a fire to cross it, given that it would be consumed before reaching the end. The entire passage area of the channels of anti-fire device 5 is practically the same as that of channel 2 of pressure compensation device 1, so that anti-fire device 5 allows the passage of air.

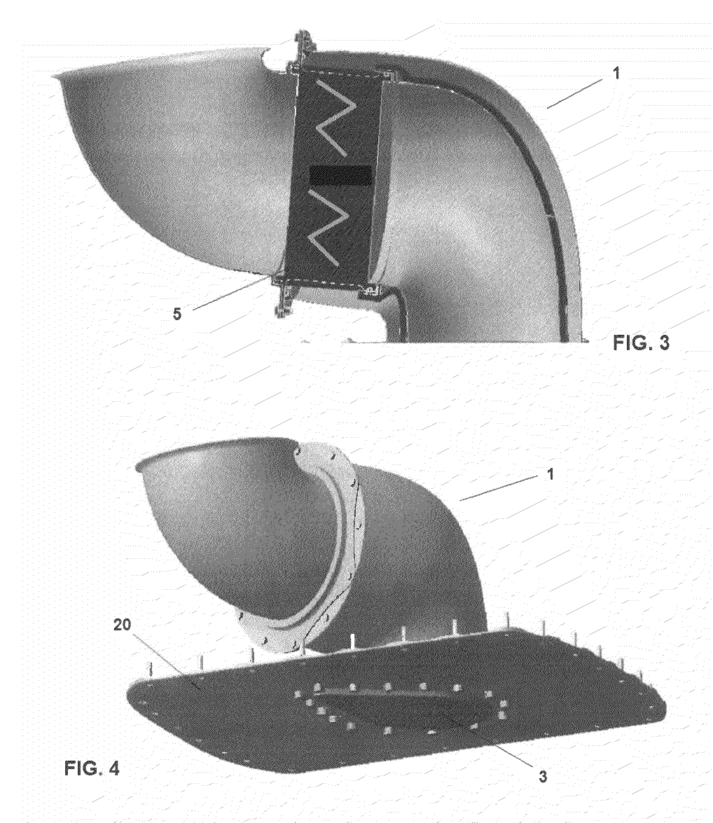

There are situations, such as the formation of ice (see FIG. 3) in which anti-fire device 5 is obturated, in which case pressure compensation device 1 ceases to fulfil its function, allowing the creation of a pressure difference between the interior and exterior of the element of the aircraft. In these cases the intervention of over pressure protection system 10 becomes necessary, which does not allow said pressure difference to reach levels that endanger the structural integrity of the aircraft.

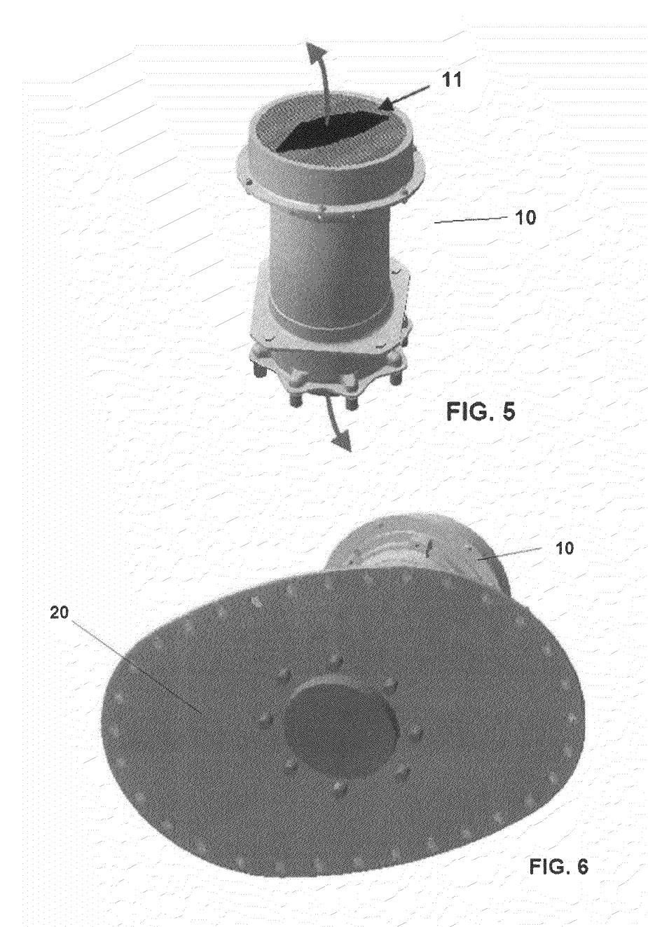

As has been mentioned, there are cases in which pressure compensation device 1 can be blocked, at which point over pressure protection system 10 enters into operation, as shown in FIG. 5.

Over pressure protection system 10 consists in a perforation of the element of the aircraft, in particular the fuel deposit, which is held shut by sheet 11, with a calibrated structural resistance that breaks when a pre-determined pressure difference is exceeded between the interior and exterior of the deposit. In this way, the passage of air through over pressure protection system 10 is enabled, which equalizes the pressures in both parts of the elements, thus avoiding submitting the structure to excessive loads.

Over pressure protection system 10 has the following operating requirements:
The rupture of sheet 11 must be readily apparent, given that a situation in which over pressure protection system 10 begins to operate is exceptional, and ruptured sheet 11 must be replaced once pressure compensation device 1 has been unblocked, because if this is not done the protection against fire provided by anti-fire device 5 would be lost.
Cover 11 must be placed above the maximum level of the combustible substance (fuel) so as to avoid spillage in the event over pressure protection system 10 enters into operation.

Just as has been commented in regard to pressure compensation device 1, over pressure protection system 10 can be mounted on an access cover 20 when the element on which it is deployed is a fuel deposit, as shown in FIG. 6.

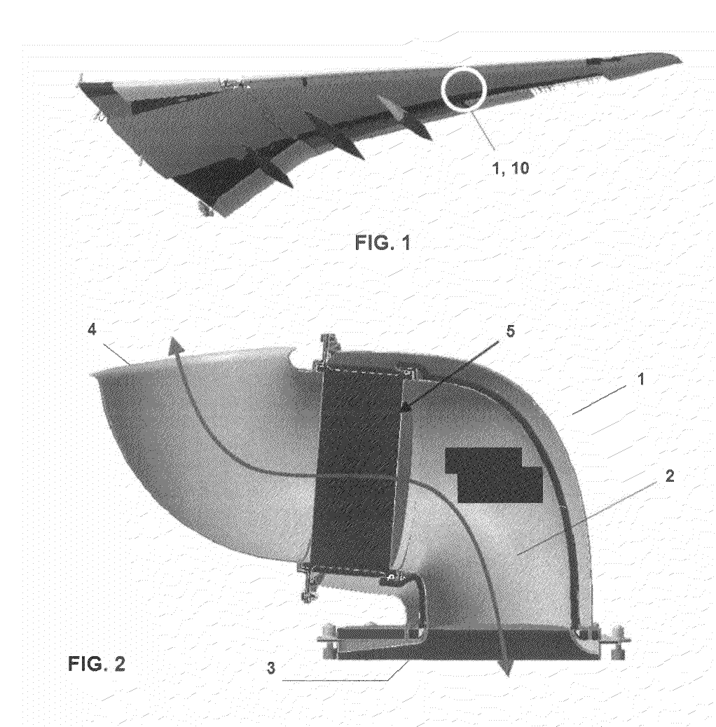

Thus pressure compensation device 1 and over pressure protection system 10 are usually installed on access covers 20 of the aircraft, in spans between adjacent or nearby ribs, as shown in FIG. 1; in the most current configurations, both systems are installed in the same span between the ribs.

In accordance with what has been previously described, the invention develops a new device, pressure compensation device 100, as can be see in

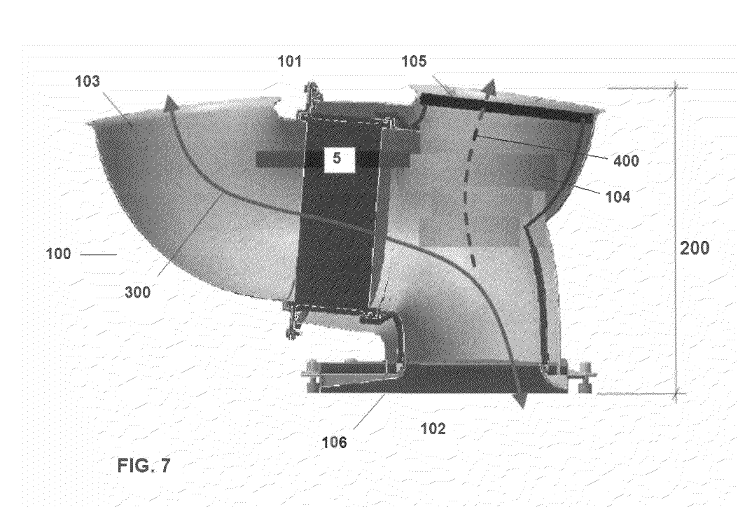

FIG. 7, in which sheet 11 of known over pressure protection system 10 is now incorporated into device 100 itself.

Pressure compensation device 100 of the invention compensates pressures between interior 101 of the element and exterior atmosphere 102, in which said element is deployed, by means of a continuous primary circulation of air 300 through a primary channel 103 in said device 100 that communicates interior 101 and exterior 102 of the element, further comprising said device 100 a secondary channel 104 integrated into said device 100 that communicates interior 101 and exterior 102 of the element. In accordance with the invention, in interior zone 101 secondary canal 104 comprises a diaphragm or sheet 105, such that in the event the constant primary circulation of air 300 through primary channel 103 is interrupted, said circulation continues through a secondary flow or circulation of air 400 to interior 101 of the element, this secondary circulation 400 having the capability of breaking sheet 105 of secondary channel 104.

Furthermore, in pressure compensation device 100, secondary channel 104 and primary channel 103 share the same communication outlet 106 towards the exterior of the element in question, as shown in FIG. 7.

Said FIG. 7 shows primary canal 103 of device 100, that comprises an anti-fire device 5 through which primary circulation 300 is carried out, and sheet 105 that is normally closed, so that when said sheet 105 is broken secondary circulation 400 begins through secondary channel 104.

In other words, in the event of obturation of primary channel 103, sheet 105 would break, allowing the passage of air through alternative secondary channel 104.

In pressure compensation device 100, height 200 of secondary channel 104 from its base is such that said secondary channel 104 remains located above the maximum level attainable by the flammable substance under pressure.

Although the present invention has been disclosed entirely in connection with the preferred embodiments, it is obvious that those modifications may be introduced that are within its scope, which should not be considered limited by the previous embodiments, but rather by the content of the following claims.

1. Pressure compensation device (100) deployed in an element that contains a flammable substance in its interior, in such a way that said device (100) compensate pressures between interior (101) of the element and exterior atmosphere (102), in which said element is deployed, by means of a continuous primary circulation (300) of air through primary channel (103) in said device (110) which communicates interior (100) and exterior (102) of the element, characterized in that said device (100) further comprises secondary channel (104) integrated in device (100) itself, that communicates interior (102) and exterior (102) of the element, comprising said secondary channel (104) in the interior zone of the element a sheet (105), such that, in the event primary continuous circulation (300) of air through primary channel (103) is interrupted, said continuous circulation continues through secondary circulation (400) of air to interior (101) of the element, this secondary circulation (400) of air being capable of breaking sheet (105) of secondary channel (104).

2. Pressure compensation device (100) in accordance with claim 1, in which secondary channel (20) and primary channel (10) share the same communication outlet (106) towards exterior (102) of the element.

3. Pressure compensation device (100) in accordance with any of the previous claims, in which sheet (105) of said secondary channel (104) comprises a sheet with a calibrated structural resistance such that said sheet (105) is capable of being broken when a pre-determined pressure difference is exceeded between interior (101) and exterior (102) of the element.

4. Pressure compensation device (100) in accordance with any of the previous claims, that furthermore comprises an anti-fire protector device (5) which allows continuous primary circulation (300) of air through primary channel (103) in said device (100), while at the same time it avoids propagation of the fire.

5. Pressure compensation device (100) in accordance with any of the previous claims, in that the element is a fuel deposit.

6. Pressure compensation device (100) in accordance with claim 5, in that the height (200) of secondary channel (104) is such that said secondary channel (104) is located above the maximum level attainable by the fuel.

7. Access to the deposit of the aircraft that comprises a pressure compensation device (100) in accordance with any of claims 1-6.

8. An aircraft that comprises in its structure a pressure compensation device (100) in accordance with any of claims 1-6.
